(19) United States
(12) Patent Application Publication
(10) Pub. No.: US 2006/0149563 A1
(43) Pub. Date: Jul. 6, 2006

(54) Business method for video counseling of relocating students

(76) Inventor: Mary Keller, Harker Heights, TX (US)

Correspondence Address: DAVID G. HENRY, 700 Texas Center, P.O. Box 1470, Waco, TX, 76703-1470, US

(21) Appl. No.: 10/849,493

(22) Filed: May 19, 2004

Related U.S. Application Data
(60) Provisional application No. 60/471,621, filed on May 19, 2003.

(51) Int. Cl. G06Q 99/00

(52) U.S. Cl. 705/1

(57) ABSTRACT

The invention is of a novel business method for a secure Interactive Counseling Center (ICC) Network providing point-to-point voice, video, data, and document image communication over the Internet in real time. The video counseling system provides a connection between losing and receiving school districts during transitions of military-connected students and helps in the transition of such students.

### CITATION TO PARENT APPLICATION(S)

This application claims the benefit of U.S. Provisional Application No. 60/471,621, filed May 19, 2003, from which priority is claimed pursuant to 35 U.S.C. 119(e).

### BACKGROUND OF THE INVENTION

1. Field of The Invention

The present invention relates to the field of counseling relocating military-connected students.

2. Background Information

The typical military family relocates every 1 to 3 years. In fact, in some instances, the length of a military family's “tour of duty” can be as little as ten months. As can well be imagined, this can cause extreme disruptions in the education of school-age children and can stress their abilities to re-establish themselves in a new school district and environment beyond healthy limits. The parents also feel the stress and frustration of attempting to obtain for their children necessary programs and help at each new duty station. For instance, it takes a lot of time and effort to cut through the red tape in order to obtain special programs for special needs children. At times, the obstacles appear unbeatable. Imagine facing this challenge every 1-3 years. Children and parents in these circumstances need all of the support educators can give them. The present invention helps educators provide this support to the families of military-connected students.

The inventor has invested four years in the development of the Interactive Counseling Center (ICC). The ICC is proven in high schools around the country. As of last count, tracking data show over 300 “calls” on ICCs. This demonstrates that the specifications of the system perform to requirement and more importantly are actually being used in the “real world” of schools. To date, 25 ICC systems and trained staffs are in place. Over 175 staff members have been trained on the ICC system and process.

The inventor, as the developer of the ICC as a total approach to “virtual counseling” through point-to-point video, voice, and data, real-time transmission system, uses a very deliberate fielding plan that assures quality from preparation to installation, to training, and through on-going support.

Because the ICC is about relationships between people the ICC is a tremendous vehicle to bridge barriers that would otherwise make transition even more of a challenge. The ICC System is proven to respond in a significant way to a great diversity of situations and a great diversity of children. What is already known from lCC's use in schools is seen in the following examples: Counselors have said that the ICC helps them work with students who are in need of translations (personally and/or for documentation such as transcripts) from languages other than English to English; and students with special needs are uniquely assisted with the ICC. The capacity of the system allows for the immediate collaboration between sending and receiving schools. Using the procedural safeguards inherent in any conference for students with special needs, parents and schools can resolve transition issues and increase the likelihood of service and accommodation continuity.

### SUMMARY OF THE INVENTION

In view of the foregoing, it is an object of the present invention to provide a novel business method, which benefits military-connected students, their families, and educators.

It is another object of the present invention to provide a novel business method for easier transition of frequently relocating military-connected students.

It is a further object of the present invention to provide a novel business method using videoconferencing and dataconferencing capabilities to ease the transition of frequently relocating military-connected students between old and new duty stations.

It is yet another object of the present invention to provide a point-to-point voice, video, data, and document image communication over the Internet in real time in order to provide a total approach to “virtual counseling” through the use of this system

In satisfaction of these and other related objectives, Applicant's present invention provides a novel business method and associated apparatus which, through the use of computer technology, allows educators to communicate more efficiently, freely, and effectively between old and new duty stations to allow for military families to more easily transition between school districts with less disruption and stress.

Applicant's approach to the problem described above is certainly simple, but it is equally unobvious. Applicant's novel business method facilitates the communications between old and new duty stations for military-connected students, allowing for an easier and more stress-free transition between school districts.

### BRIEF DESCRIPTION OF THE DRAWINGS

FIG. 1 is an illustration of the Interactive Counseling Center (ICC) presentation and facility.

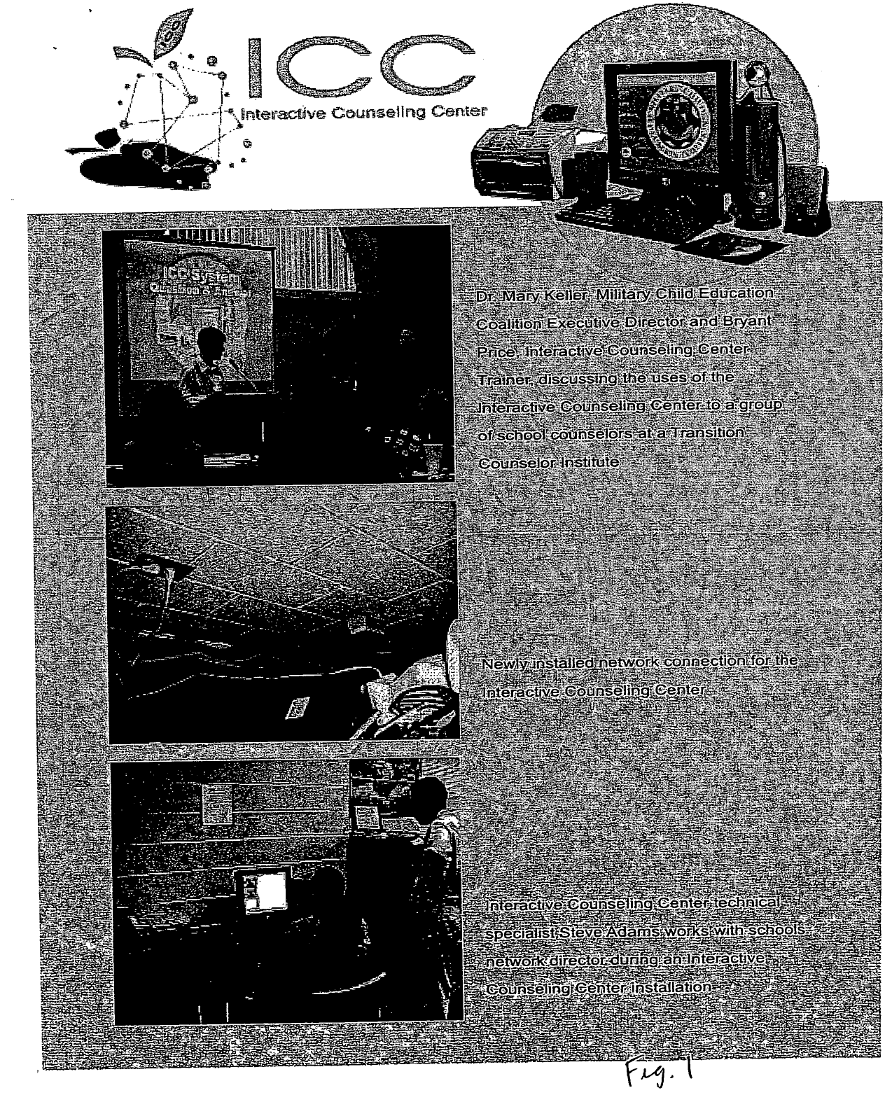

FIG. 2 is an illustration of typical ICC facility requirements.

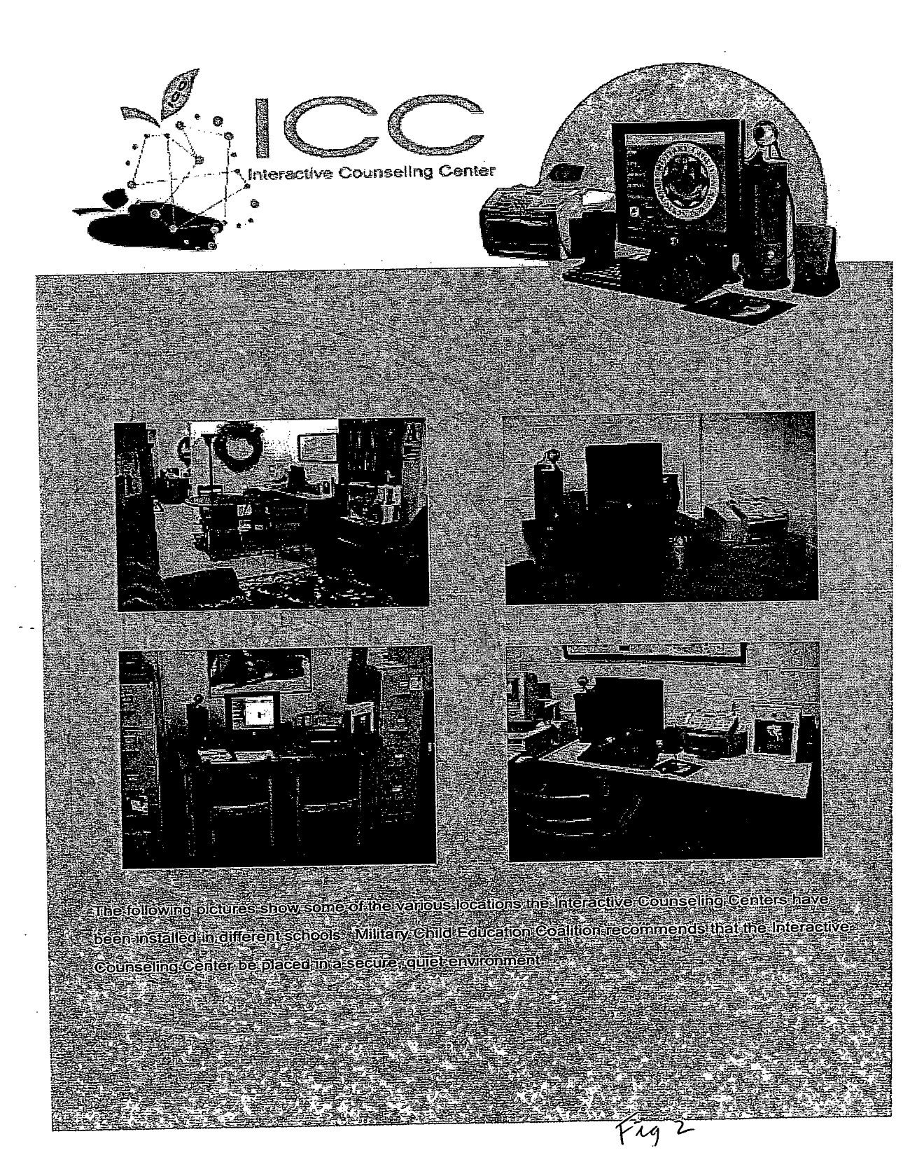

FIG. 3 is an illustration of typical ICC personnel and facilities.

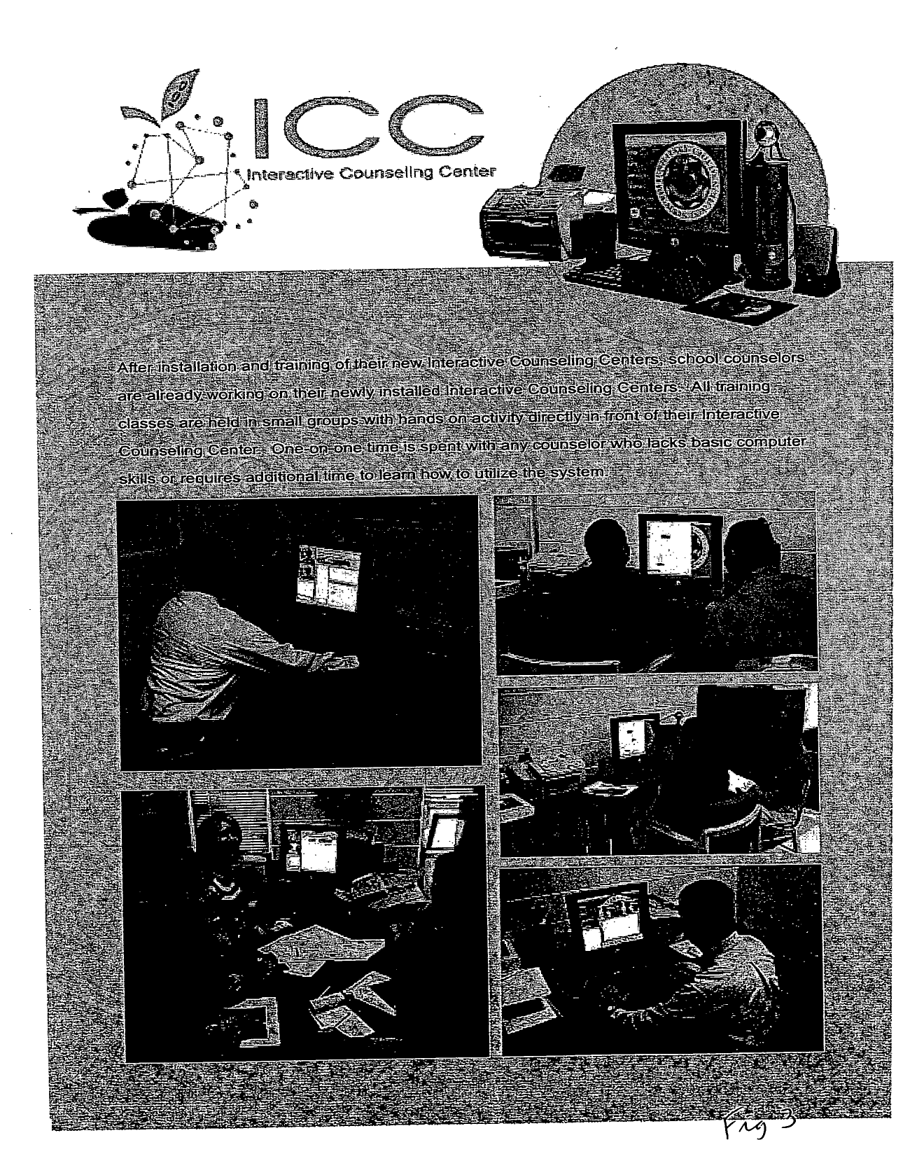

FIG. 4 is an illustration of typical ICC personnel and facilities.

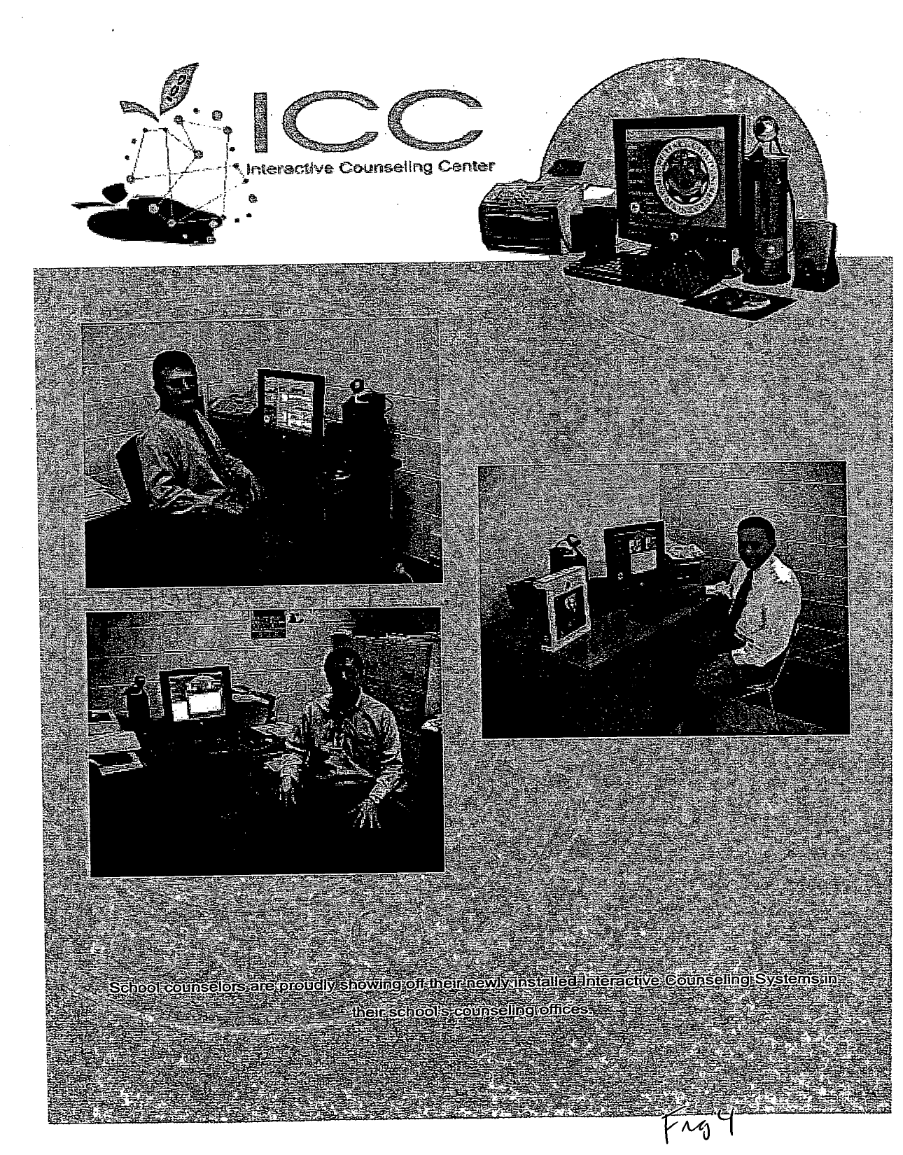

FIG. 5 is an example of an ICC Location/Installation Information checklist.

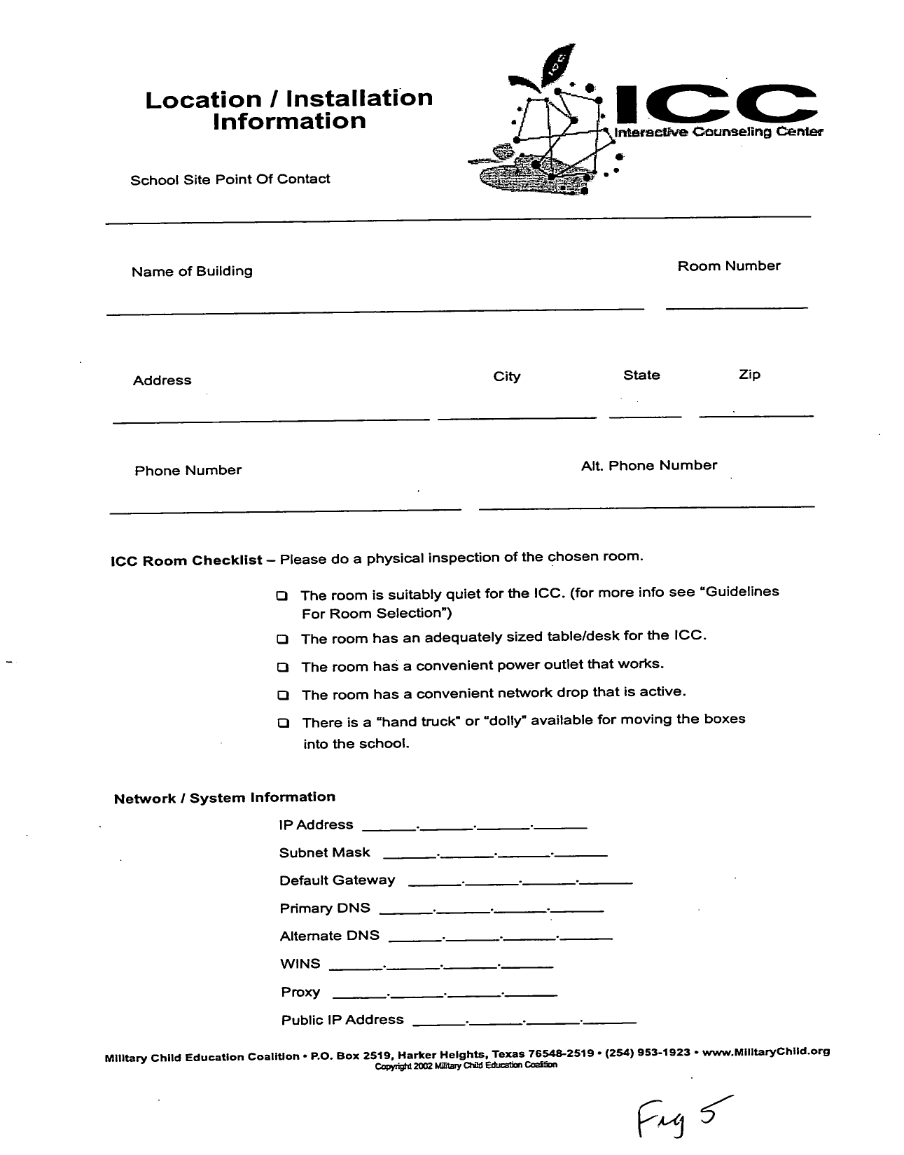

FIG. 6 is an example of an ICC School Contact Information checklist.

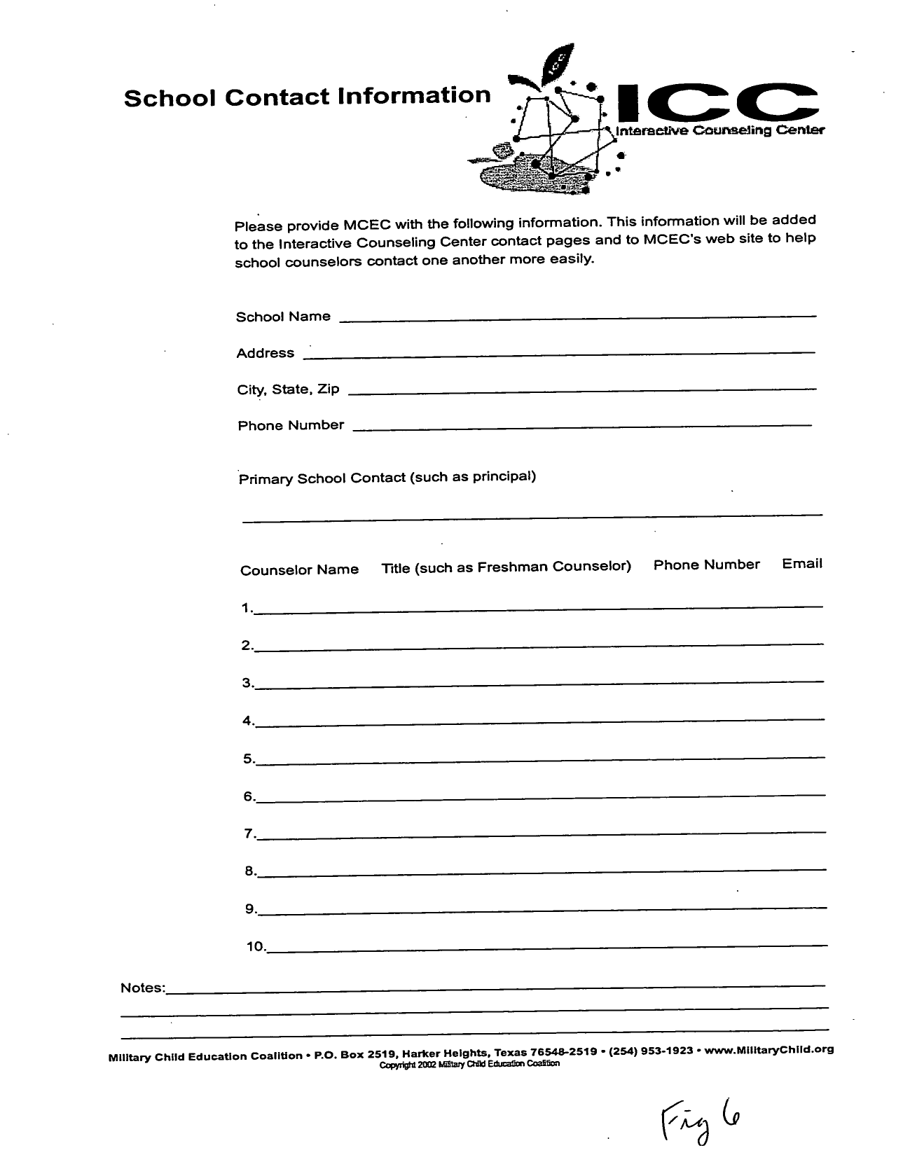

FIG. 7 is an example of an ICC Technology Contact Information checklist.

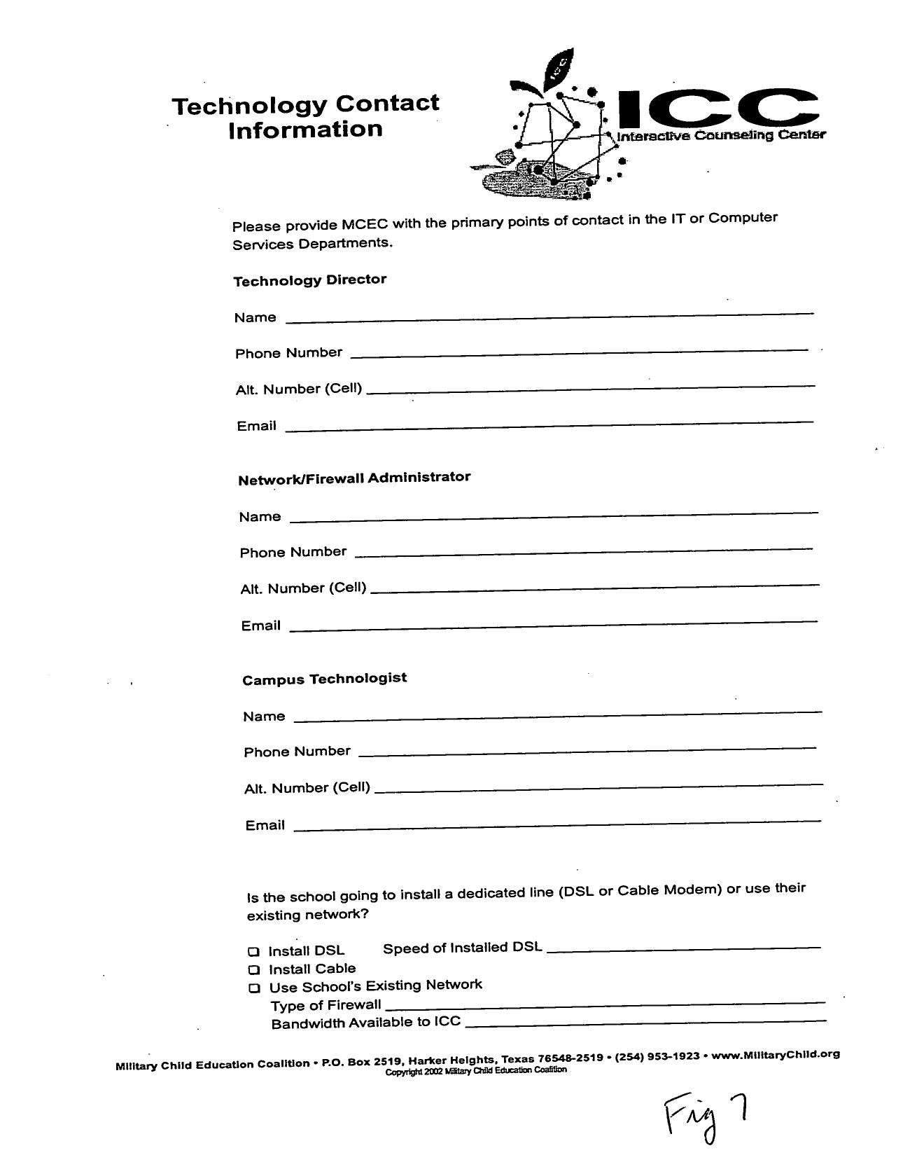

### DETAILED DESCRIPTION OF THE PREFERRED EMBODIMENT

Overview of the Interactive Counseling System: This system is operated on a secure Interactive Counseling Center (ICC) Network providing point-to-point voice, video, data, and document image communication over the Internet in real time. It provides a total approach to “virtual counseling” through the use of this system This proprietary video counseling system provides a connection between losing and receiving school districts during transitions of military-connected students. Currently, there are 25 major civilian school districts in the United States who support military installations that are already a part of the ICC Network, providing the DoD (Department of Defense) Education Activity the ability to establish secure communication with these districts in each transition—both in and out of DoDEA schools—for military students.

The Video Counseling System incorporates the ICC, including both hardware and proprietary software, which Connections between locations is accomplished via the Interactive Counseling Center (ICC) Network to secure point-to-point voice, video, data, and document image communication over the internet in real-time. Connections through the internet are made by the ICC Network. Both hardware and software are provided as part of the system package. The computer hardware and the Microsoft software on the machines have been modified under special arrangements with Dell Computers and Microsoft to accommodate the requirements of the ICC software to ensure security and allow for secure authorized records sharing between schools. Installation at each site is performed by authorized technicians. On-site training is included in the installation of each ICC system. In addition to on-site training, each ICC includes a full color manual and a training videotape.

When a user places a call, the following events take place:
1. the caller passes a request to our servers
2. the caller is authenticated if authentication fails, further progress is denied
3. information necessary to contact the target system is passed back to the caller
4. the caller passes a connection request to the target system
5. the target system authenticates the caller if authentication fails, further progress is denied
6. the target system replies as available or unavailable
7. the caller authenticates the reply from the target if authentication fails, further progress is denied.
8. if the target's reply was available, the caller connects directly with the target - if the reply was unavailable, the user is prompted to attempt a connection again at a later time.

The system is based on a standard version of Microsoft Windows XP Professional. The following system modifications have been put in place:
1. All pertinent service packs, critical updates˜recommended updates, software updates, and driver updates have been installed via Microsoft Windows Update.
2. The following Windows components have been removed or disabled:
   Games
   Accessories—except Paint
   Fax Services
   Indexing Service
   IIS—All
   Management and Monitoring Tools—All
   Message Queuing—All
   MSN Explorer
   Networking Services—All
   Print Services for Unix
   Outlook Express
   Windows Messenger
3. The following services have been removed or disabled:
   SSDP Discovery Service
   TCP/IP NetBIOS Helper
   TCP/IP Print Server
   Telephony
   Telnet
   Terminal Services
   Themes
   Universal Plug and Play Device Host
   Wireless Zero Configuration
   World Wide Web Publishing
4. The following Network options are disabled or unavailable:
   Client Service for Netware, depending on network installation
   Service Advertising Protocol
   File and Printer Sharing for Microsoft Networks
   Various WINS items, depending on network installation
5. The following tools from Gibson Research Corporation (grc.com) are run on the machine:
   UnPlug n' Pray—Disables Microsoft s Universal Plug and Play Network Support
   SocketLock—Disables Raw Socket Access to All Users
6. Misc and Errata:
   Administrator access to the machine requires a 36+ random character password
   Files with administrator privileges are not available to Users
   Fast User Switching is Disabled
   Users operate under the Limited Account setting

Technical Information and Specifications

The Interactive Counseling Center is a point-to-point H.323 and T.120 protocol based video/data conferencing tool. As an IP based solution, it brings powerful Videoconferencing and Dataconferencing capabilities to a location without the high price and labor demands of conventional Videoconferencing systems and their associated components.

The ICC system uses a standard Internet connection of DSL grade or higher (100 kbps), or can run through the school's existing network if there is enough available bandwidth. Although the ICC can function on less bandwidth than is provided with DSL, there is an increased potential for overhead bandwidth shortages when utilizing a lesser connection speed.

For maximum functionality and compatibility, it is recommended that the ICC be installed outside of any NAT (Network Address Translation) devices such as firewalls and routers and be given a static, real-world IP address. This eliminates many of the potential setup difficulties for the ICC system, and requires no changes or minimal changes to the current network.

If the system is to be set up inside of the existing network, one should use NAT so that the system can have a real-world IP address. One may also use port forwarding or triggering, as this will still allow the system to receive calls. For both NAT and port forwarding, one will need to have the following ports open: 389—LDAP, 522—ULS, 1002—ILS, 1503—T.120, 1720—H.323, 1731—ACC, 3389—RDC, and in some cases a dynamic TCP+UDP range for NV/data streams that can be from 1045-65635. The ICC may be able to take advantage of a DMZ port in the facility's network, but functionality cannot be guaranteed. Please be aware that not all firewalls and routers are compatible with H.323 even though one can make the port available.

If more installation options are needed, one may use an H.323 Gatekeeper device. A Microsoft Internet Security and Acceleration Server (ISA server) can be set up to function as an appropriate H.323 Gatekeeper device. Other options for setting up an H.323 Gatekeeper device are available for both Windows and Linux, but functionality cannot be guaranteed.

MCEC provides on-site installation and training with the ICC system. MCEC's goal is to provide as smooth and as trouble-free an installation as possible. The cooperation of the school helps to make this a quick, no headache process. The ICC is a no/low maintenance unit from a computer services perspective. 95% of all maintenance and upgrades can be done without any end user interaction. Any repairs or upgrades requiring more than a brief interaction with the system will be handled by exchanging system boxes.

Conference Call Agenda

What Is the Interactive Counseling Center and what is included with it?
The ICC is an internet based tool designed to help build relationships between counselors, parents, & students for the purpose of easing the transition of students between schools.
The ICC includes a computer, monitor, printer/scanner unit, camera, and all peripherals and cables required for it to function and allow video conferencing and document exchange between distant stations.

How can a school system obtain an interactive Counseling Center?
All school systems/Districts that are MCEC members are given one ICC per district on a long term lease. Other ICCs may be purchased for $5000 each.
It is expected that school districts who obtain an ICC will have at least one counselor trained in the Transition Counselor Institute.
The long term lease agreement must be reviewed and appropriately signed prior to installation of the ICC.

What is the school responsible for providing?
A room conforming to the “Room Selection Guidelines”
Internet access at DSL speeds or higher.

How Important are the “Room Selection Guidelines”?
Not following these guidelines can result in an awkward conference experience.
A conference is sometimes a person's first look at a school. You want to make a good impression.

What are the network requirements for the ICC?
Access to the Internet at a minimum of 100 kbps.
A public static IP address for use as a “phone number”.
Firewall permissions accommodating full ICC functionality.

How are the ICC warranty claims and upgrades handled?
Problems with the ICC equipment are handled by exchange.
Upgrades to the software are handled via Internet.

What needs to be completed before Installation and training can be scheduled?
A completed “School Contact Information” sheet needs to be faxed to MCEC.
A completed “Location/Installation Information” sheet needs to be faxed to MCEC.
A completed “Technology Contact Information” sheet needs to be faxed to MCEC.
A successful Audio/Video/Data test call needs to be completed with your facility.
If key people are not attending the conference call, they should be informed of the events that will take place.
MCEC's fax number is 254-953-1925.
   Room Selection Guidelines

The Interactive Counseling Center is designed to facilitate communication between schools.

Since the ICC is about visual communication, it would be better for the ICC to be placed in such a fashion that the room would be deeper rather than wider from the camera's perspective. There may be several people utilizing the system during a conference call, so there should be enough space and seating in the location where the ICC is placed to accommodate these people comfortably. There should also be an adequately sized desk or table to place the ICC on. One of the things the ICC was designed to work with are student records. As such, it should not be available for unsupervised and/or indiscriminate use. A lockable room is highly recommended.

Another factor to consider is the lighting in a room. For larger rooms, even lighting through the room is best. For smaller rooms, take care to avoid lighting that causes shadows on a person's face. If the chosen room is dark, try adding a floor lamp to the room. Avoid rooms with windows in the background as excessive amounts of light can cause you to become backlit and the video to be unrecognizable.

The ICC functions best when there is a minimal amount of background noise present. Make sure your location Is away from noisy areas. This may include hallways, cafeterias, busy work rooms, gyms, etc. Also, keep in mind that things like air conditioning vents, copy machines, and vending machines do make noise and could interfere with the conference experience. Places like a conference room in the office, or a media room in a library can work well.

Although the invention has been described with reference to specific embodiments, this description is not meant to be construed in a limited sense. Various modifications of the disclosed embodiments, as well as alternative embodiments of the inventions will become apparent to persons skilled in the art upon reference to the description of the invention. It is, therefore, contemplated that the appended claims will cover such modifications that fall within the scope of the invention.

I claim:

1. A business method for providing videoconferencing and dataconferencing capabilities between a plurality of schools comprising the steps of:
selecting appropriate computer hardware and software;
installing said computer hardware and software in school facility;
training school staff in the usage of said computer hardware and software; and
establishing communication between said plurality of schools.
